(19) United States
(12) Patent Application Publication
(10) Pub. No.: US 2015/0103191 A1
(43) Pub. Date: Apr. 16, 2015

(54) IMAGING APPARATUS AND DETECTING APPARATUS

(71) Applicant: Panasonic Intellectual Property Managment Co., Ltd., Osaka (JP)

(72) Inventors: Motonori OGURA, Osaka (JP); Yuji UEDA, Osaka (JP); Takeyuki HASEGAWA, Osaka (JP)

(21) Appl. No.: 14/576,673

(22) Filed: Dec. 19, 2014

Related U.S. Application Data
(63) Continuation of application No. PCT/JP2013/004911, filed on Aug. 20, 2013.

(30) Foreign Application Priority Data
Jan. 24, 2013 (JP) 2013-010999

(51) Int. Cl. H04N 5/232

(52) U.S. Cl. CPC H04N 5/23251
USPC 348/208.3

(57) ABSTRACT

An imaging apparatus and a detecting apparatus are provided. The imaging apparatus includes the following elements: an imaging part for imaging the light condensed by an optical system and for generating image data; a first sensor for detecting a first angular velocity, i.e. an angular velocity around a first axis, which is substantially parallel to the optical axis of the optical system; a second sensor for detecting a second angular velocity, i.e. an angular velocity around a second axis, which is substantially perpendicular to a horizontal plane when the apparatus is placed on the horizontal plane; a third sensor for detecting an angle of rotation around a third axis, which is substantially perpendicular to the plane formed by the first axis and the second axis; and a processor for processing information about the first angular velocity, based on information about the second angular velocity and information about the angle.

### BACKGROUND

1. Field

The present disclosure relates to an imaging apparatus and a detecting apparatus.

2. Description of the Related Art

Patent Literature 1 (see Japanese Patent Unexamined Publication No. 2002-94877) discloses an electronic camera. This electronic camera includes the following elements: a memory for storing a video signal subjected to camera shake correction; and a coordinate transformation means connected to the memory, for performing rotational coordinate transformation in which the center of the image of the video signal is the origin.

This configuration allows this electronic camera to correct a tilt easily.

### SUMMARY

The present disclosure provides an imaging apparatus and a detecting apparatus that can more precisely detect a tilt that is caused, without the intention of the user, in the direction of rotation around an axis substantially parallel to the optical axis.

The imaging apparatus of the present disclosure includes the following elements: an imaging part for imaging the light condensed by an optical system and for generating image data; a first sensor for detecting a first angular velocity, i.e. an angular velocity around a first axis, which is substantially parallel to the optical axis of the optical system; a second sensor for detecting a second angular velocity, i.e. an angular velocity around a second axis, which is substantially perpendicular to a horizontal plane when the apparatus is placed on the horizontal plane; a third sensor for detecting an angle of rotation around a third axis, which is substantially perpendicular to the plane formed by the first axis and the second axis; and a processor for processing information about the first angular velocity, based on information about the second angular velocity and information about the angle.

The detecting apparatus of the present disclosure includes the following elements: a first sensor for detecting a first angular velocity, i.e. an angular velocity around a first axis, which is substantially parallel to the optical axis of the optical system; a second sensor for detecting a second angular velocity, i.e. an angular velocity around a second axis, which is substantially perpendicular to a horizontal plane when the apparatus is placed on the horizontal plane; a third sensor for detecting an angle of rotation around a third axis, which is substantially perpendicular to the plane formed by the first axis and the second axis; and a processor for processing information about the first angular velocity, based on information about the second angular velocity and information about the angle.

### BRIEF DESCRIPTION OF DRAWINGS

FIG. 1 is a schematic view for explaining rotary axes related to digital video camera 100.

FIG. 2 is a block diagram showing an electrical configuration of digital video camera 100.

FIG. 3 is a block diagram showing a configuration related to tilt correction processing.

FIG. 4A is a schematic diagram for explaining a method for calculating an inclination angle of digital video camera 100.

FIG. 4B is a schematic diagram for explaining a method for calculating a tilt angle of digital video camera 100.

FIG. 5A is a schematic diagram for explaining gyro output when the tile angle is not present.

FIG. 5B is a schematic diagram for explaining gyro output when the tile angle is present.

### DETAILED DESCRIPTION

Hereinafter, exemplary embodiments will be detailed with reference to the accompanying drawings as needed. However, unnecessarily detailed description may be omitted. For instance, the detailed description of a matter that is already well known and the description of substantially identical elements may be omitted. This is to avoid the following description from being redundant and to help those skilled in the art easily understand the present disclosure.

The inventors provide the accompanying drawings and the following description to help those skilled in the art sufficiently understand the present disclosure. The drawings and the description are not intended to limit the subject matter described in the scope of the claims.

### First Exemplary Embodiment

Hereinafter, the first exemplary embodiment is described with reference to the accompanying drawings.

### [1. Outline]

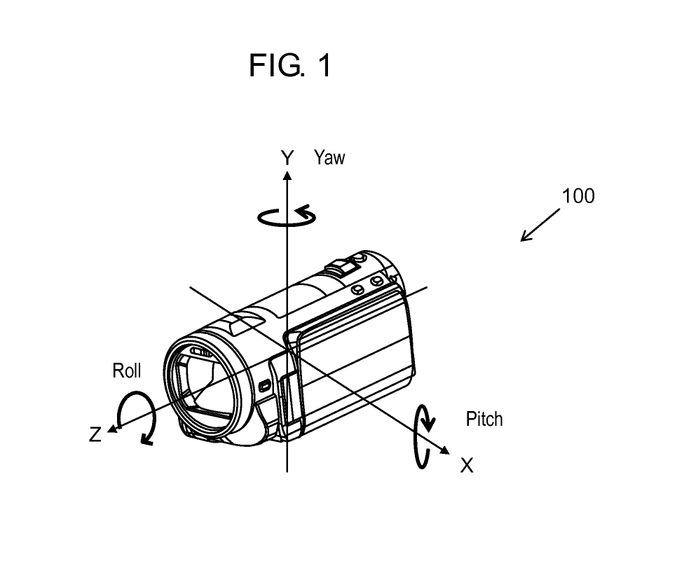

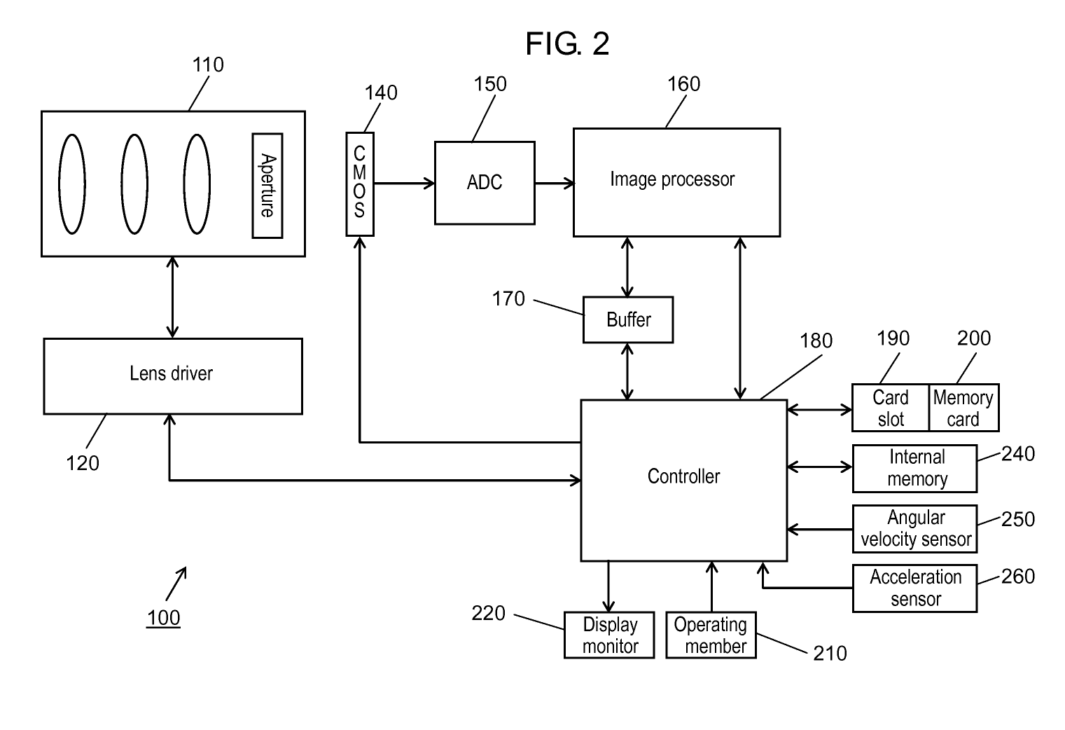

Digital video camera 100 is outlined with reference to FIG. 1 and FIG. 2. FIG. 1 is a schematic view showing an outline of digital video camera 100. FIG. 2 is a block diagram showing an electrical configuration of digital video camera 100. As shown in FIG. 1, the direction of rotation around a Z axis, which is substantially parallel to the optical axis, with respect to digital video camera 100 is referred to as a roll direction. The direction of rotation around a Y axis with respect to digital video camera 100 is referred to as a yaw direction. Here, the Y axis is substantially perpendicular to a horizontal plane when digital video camera 100 is placed on the horizontal plane. When digital video camera 100 is tilted at a predetermined angle with respect to the horizontal plane, the Y axis is tilted at the same angle in the same direction in which digital video camera 100 is tilted. The direction of rotation around an X axis with respect to digital video camera 100 is referred to as a pitch direction. Here, the X axis is substantially perpendicular to the plane formed by the Z axis and the Y axis.

Digital video camera 100 has a function of reducing the effect of a tilt on the image taken. Here, the tilt means a tilt that is caused in the roll direction without the intention of the user. Tilts include a static tilt and a dynamic tilt. The static tilt is caused when the user holds digital video camera 100 at a predetermined angle in the roll direction. The dynamic tilt is a shake in the roll direction caused by the shaking of the user's hands, for example, when the user holds digital video camera 100.

Assume that the user rotates digital video camera 100 around an axis perpendicular to the horizontal plane in the state where digital video camera 100 is tilted at a predetermined angle in the pitch direction. Though detailed later, the rotation of digital video camera 100 around the axis perpendicular to the horizontal plane has a component of rotation in the yaw direction and a component of rotation in the roll direction of digital video camera 100. However, the component of rotation in the roll direction is generated not by actually rotating the image taken by digital video camera 100 in the roll direction. If processing is performed to reduce the effect of the component of rotation in the roll direction on the taken image, this means that digital video camera 100 rotates the taken image that has not been rotated. That is, in this case, digital video camera 100 erroneously detects the component of rotation in the roll direction.

Digital video camera 100 includes the following elements: complementary metal-oxide semiconductor (CMOS) image sensor 140; angular velocity sensor 250R; angular velocity sensor 250Y; acceleration sensor 260; and controller 180. CMOS image sensor 140 images the light condensed by optical system 110 and generates image data. Angular velocity sensor 250R detects a first angular velocity, i.e. an angular velocity around a first axis, which is substantially parallel to the optical axis of optical system 110. Angular velocity sensor 250Y detects a second angular velocity, i.e. an angular velocity around a second axis, which is substantially perpendicular to a horizontal plane when the digital video camera is placed on the horizontal plane. Acceleration sensor 260 detects an angle of rotation around a third axis, which is substantially perpendicular to the plane formed by the first axis and the second axis. Controller 180 processes information about the first angular velocity, based on information about the second angular velocity and information about the angle.

With this configuration, digital video camera 100 can more precisely detect a tilt that is caused, without the intention of the user, in the direction of rotation around an axis substantially parallel to the optical axis.

### [2. Electrical Configuration of Digital Video Camera 100]

An electrical configuration of digital video camera 100 is described with reference to FIG. 2. In digital video camera 100, CMOS image sensor 140 takes an object image that is formed by optical system 110 composed of one lens or a plurality of lenses. The image data generated by CMOS image sensor 140 is subjected to various types of processing in image processor 160, and is stored in memory card 200. Hereinafter, a configuration of digital video camera 100 is detailed.

Optical system 110 includes a zoom lens, a camera shake correction lens, a focusing lens, and an aperture. Moving the zoom lens along the optical axis can magnify and reduce the object image. Moving the focusing lens along the optical axis can adjust focusing on the object image. The camera shake correction lens is movable in the plane perpendicular to the optical axis of optical system 110. When the camera shake correction lens is moved in the direction in which the shake of digital video camera 100 is cancelled out, the effect of the shake of digital video camera 100 on the taken image can be reduced. The aperture adjusts the size of the opening depending on the user's setting or automatically so as to adjust the amount of light transmission.

Optical system 110 also includes a zoom actuator for driving the zoom lens, a camera shake correction actuator for driving the camera shake correction lens, a focusing actuator for driving the focusing lens, and an aperture actuator for driving the aperture.

Lens driver 120 drives the various lenses and the aperture included in optical system 110. For instance, lens driver 120 controls the zoom actuator, the focusing actuator, the camera shake correction actuator, and the aperture actuator included in optical system 110.

CMOS image sensor 140 takes the object image formed by optical system 110 and generates image data. CMOS image sensor 140 performs various operations, such as exposure, transfer, and electronically shuttering.

A/D converter 150 converts analog image data generated in CMOS image sensor 140 into digital image data.

Image processor 160 performs various types of processing on the image data generated in CMOS image sensor 140, and thereby generates image data to be displayed on display monitor 220 or image data to be stored in memory card 200. For instance, image processor 160 performs various types of processing, e.g. gamma correction, white balance correction, and blemish correction, on the image data generated in CMOS image sensor 140. Image processor 160 also compresses the image data generated in CMOS image sensor 140 in a compressed format, for example, in conformity with the H.264 standard or the MPEG2 standard. Image processor 160 can be implemented as a digital signal processor (DSP) or a microcomputer.

Image processor 160 can reduce the effect of a tilt that is exerted on the image formed on CMOS image sensor 140, by performing rotation processing on the image data. For instance, assume that a user takes an object image in the state where digital video camera 100 is tilted at an angle of θ (degrees) in the counterclockwise direction. In this case, an image of the object tilted at θ (degrees) in the clockwise direction is taken. At this time, image processor 160 clips image data in the state where the position tilted at θ (degrees) in the clockwise direction is set to a clipping position. Then, image data in which the object is not tilted is clipped. In this manner, image processor 160 generates an image where the amount of tilt is reduced.

Controller 180 is a controlling means for controlling the whole of digital video camera 100. Controller 180 generates vertical synchronizing signals at 60 (fps). Image processor 160 performs tilt correction processing on the taken image in a cycle of the vertical synchronizing signal, for example. This operation provides an image subjected to appropriate tilt correction. Controller 180 can be implemented as a semiconductor device, for example. Controller 180 may be formed of hardware only, or formed of hardware and software in combination. Controller 180 can be implemented as a microcomputer, for example.

Buffer 170 functions as a working memory for image processor 160 and controller 180. Buffer 170 is implemented as a dynamic random-access memory (DRAM), a ferroelectric memory, or the like.

Memory card 200 is attachable to and detachable from card slot 190. Card slot 190 is mechanically and electrically connectable to memory card 200. Memory card 200 contains a flash memory or a ferroelectric memory, and can store data, such as an image file, generated in image processor 160.

Internal memory 240 is formed of a flash memory, a ferroelectric memory, or the like. Internal memory 240 stores a control program, for example, for controlling the whole of digital video camera 100.

Operating member 210 is a generic term of the user interface that accepts operations performed by the user. Examples of operating member 210 include arrow keys and an enter button to be used for accepting operations of the user.

Display monitor 220 can display an image represented by the image data that has been generated in CMOS image sensor 140, or an image represented by the image data that has been read out from memory card 200. Display monitor 220 can also display various types of menus that allow the user to make various settings of digital video camera 100.

Angular velocity sensor 250 is a sensor for detecting an angular velocity. Angular velocity sensor 250 has angular velocity sensor 250R for detecting an angular velocity in the roll direction and angular velocity sensor 250Y for detecting an angular velocity in the yaw direction as shown in FIG. 1.

Acceleration sensor 260 is a sensor for detecting acceleration. Acceleration sensor 260 has acceleration sensor 260X for detecting acceleration in the X-axis direction, acceleration sensor 260Y for detecting acceleration in the Y-axis direction, and acceleration sensor 260Z for detecting acceleration in the Z-axis direction as shown in FIG. 1.

### [3. Tilt Correction Processing]

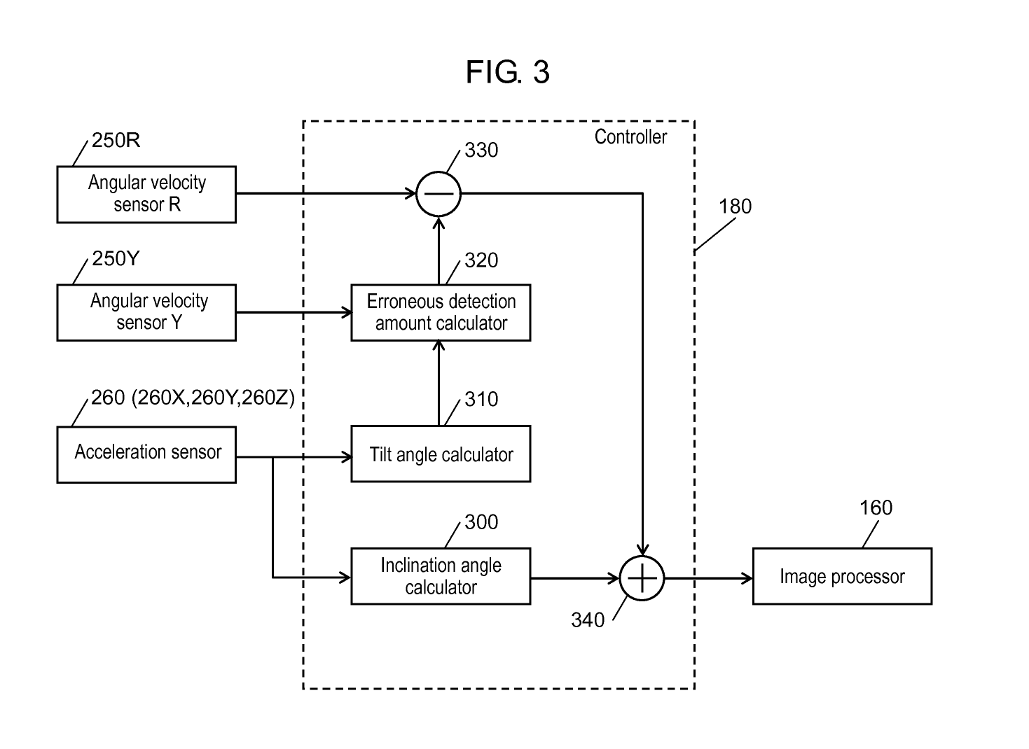

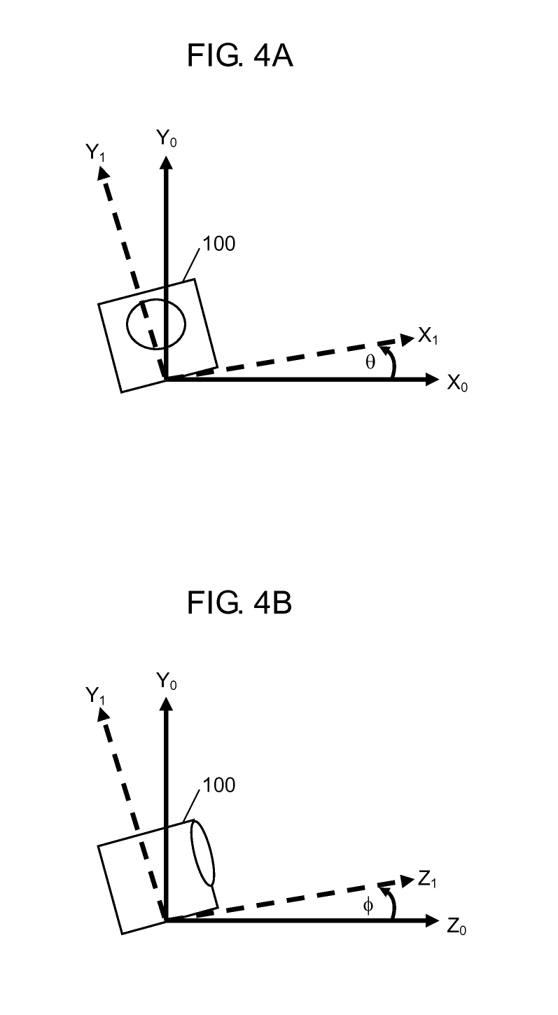

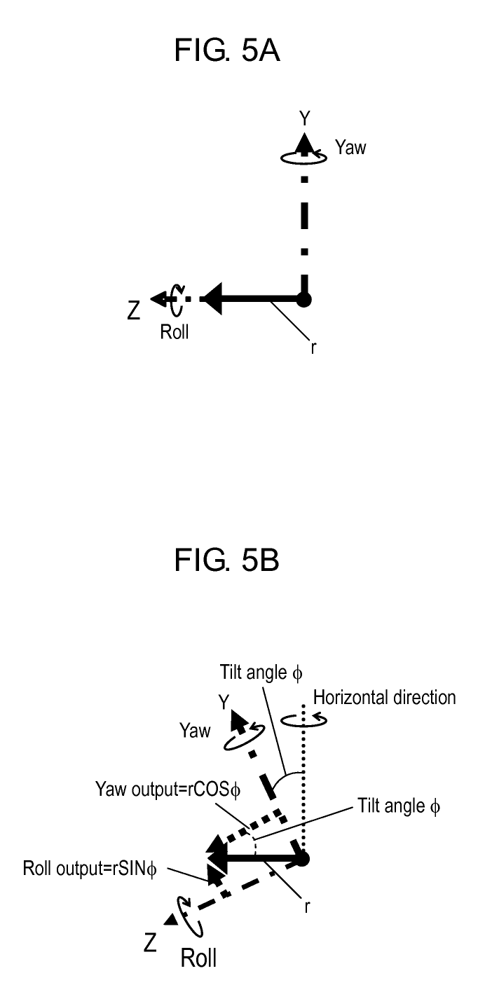

A description is provided for the processing of correcting an angle of rotation in digital video camera 100, with reference to FIG. 3 through FIG. 5B. FIG. 3 is a block diagram showing a configuration related to tilt correction processing in digital video camera 100. FIG. 4A is a schematic diagram for explaining a method for calculating a inclination angle of digital video camera 100. FIG. 4B is a schematic diagram for explaining a method for calculating a tilt angle of digital video camera 100. FIG. 5A is a schematic diagram for explaining output of angular velocity sensor 250 when the tilt angle is not present. FIG. 5B is a schematic diagram for explaining output of angular velocity sensor 250 when the tilt angle is present.

The processing of correcting the angle of rotation in digital video camera 100 is performed by sequentially carrying out Step 1 through Step 4. Step 1 is a step of calculating an inclination angle i.e. a static tilt, and a tilt angle of digital video camera 100. Step 2 is a step of calculating the amount of erroneous detection of a dynamic tilt from the output of angular velocity sensor 250Y and the tilt angle calculated in Step 1. Step 3 is a step of calculating the dynamic tilt to be corrected, by subtracting the amount of erroneous detection of the dynamic tilt from the output of angular velocity sensor 250R. Step 4 is a step of calculating the tilt to be corrected, by adding the inclination angle as the static tilt that has been calculated in Step 1 and the dynamic tilt to be corrected that has been calculated in Step 3. Hereinafter, a description is provided for Step 1 through Step 4 in order.

### [3-1. Step 1]

First, in Step 1, as shown in FIG. 3, inclination angle calculator 300 and tilt angle calculator 310 obtain the output from acceleration sensor 260. Specifically, inclination angle calculator 300 and tilt angle calculator 310 obtain information on acceleration in the X-axis direction, information on acceleration in the Y-axis direction, and information on acceleration in the Z-axis direction of digital video camera 100.

Based on each type of information obtained, inclination angle calculator 300 calculates an inclination angle of digital video camera 100. The method for calculating the inclination angle is described with reference to FIG. 4A. Here, the inclination angle is set to θ (degrees). The X₀ axis represents the X axis when digital video camera 100 is not tilted. The X₁ axis represents the X axis when digital video camera 100 is tilted at an inclination angle of θ (degrees). The Y₀ axis represents the Y axis when digital video camera 100 is not tilted. The Y₁ axis represents the Y axis when digital video camera 100 is tilted at an inclination angle of θ (degrees).

The inclination angle of θ (degrees) is calculated with following Expression (1):

$$\begin{matrix}[ Numerical expression 1 ] & \\ θ = {tan}^{1} ( \frac{{X}_{1}}{\sqrt{{Y}_{1}^{2} + {Z}_{1}^{2}}} ) & Expression ( 1 )\end{matrix}$$

In Expression (1), X₁ is the output of acceleration sensor 260X. That is, X₁ represents acceleration in the X₁-axis direction. Y₁ is the output of acceleration sensor 260Y. That is, Y₁ represents acceleration in the Y₁-axis direction. Z₁ is the output of acceleration sensor 260Z. That is, Z₁ represents acceleration in the Z₁-axis direction.

Based on each type of information obtained, tilt angle calculator 310 calculates a tilt angle of digital video camera 100. The method for calculating the tilt angle is described with reference to FIG. 4B. Here, the tilt angle is set to φ (degrees). The Z₀ axis represents the Z axis when digital video camera 100 is not tilted. The Z₁ axis represents the Z axis when digital video camera 100 is tilted at a tilt angle of φ (degrees).

The tilt angle of φ (degrees) is calculated with following Expression (2):

$$\begin{matrix}[ Numerical expression 2 ] & \\ φ = {tan}^{1} ( \frac{{Z}_{1}}{\sqrt{{X}_{1}^{2} + {Y}_{1}^{2}}} ) & Expression ( 2 )\end{matrix}$$

Here, X₁, Y₁, and Z₁ in Expression (2) are the same as those in Expression (1).

Inclination angle calculator 300 and tilt angle calculator 310 calculate an inclination angle of digital video camera 100 as a static tilt, and a tilt angle of digital video camera 100, by performing calculation processing based on Expression (1) and Expression (2), respectively.

### [3-2. Step 2]

Next, in Step 2, as shown in FIG. 3, erroneous detection amount calculator 320 obtains information on the angular velocity in the yaw direction of digital video camera 100 from angular velocity sensor 250Y, and obtains information on the tilt angle of digital video camera 100 from tilt angle calculator 310. Erroneous detection amount calculator 320 calculates the amount of erroneous detection regarding a dynamic tilt, based on the obtained information on the angular velocity in the yaw direction and the information on the tilt angle of digital video camera 100.

A description is provided for the reason why the dynamic tilt is erroneously detected and a method for calculating the amount of erroneous detection, with reference to FIG. 5A and FIG. 5B. When the tilt angle of digital video camera 100 is 0 (degree) as shown in FIG. 5A, rotating digital video camera 100 in the yaw direction generates centrifugal force r. In this case, angular velocity sensor 250Y calculates an angular velocity by detecting centrifugal force r. Angular velocity sensor 250R does not detect centrifugal force r. That is, since digital video camera 100 is not rotated in the roll direction, angular velocity sensor 250R calculates 0 (degree/second) as an angular velocity. In this case, digital video camera 100 does not make erroneous detection regarding the dynamic tilt of digital video camera 100.

In contrast, as shown in FIG. 5B, assume that the tilt angle of digital video camera 100 is φ (degrees). In this case, rotating digital video camera 100 in the horizontal direction shown in FIG. 5B generates centrifugal force r. Angular velocity sensor 250Y detects the component of r·cos φ as a centrifugal force in centrifugal force r. Angular velocity sensor 250R detects the component of r·sin φ as a centrifugal force in centrifugal force r. However, even when digital video camera 100 is rotated in the horizontal direction shown in FIG. 5B, digital video camera 100 does not rotate in the roll direction actually. That is, digital video camera 100 erroneously detects the component of r·sin φ as a dynamic tilt.

Erroneous detection amount calculator 320 can calculate the amount of dynamic tilt erroneously detected by angular velocity sensor 250R, based on the information on the angular velocity in the yaw direction that has been obtained from angular velocity sensor 250Y. As shown in FIG. 5B, the ratio of the effect of centrifugal force r on angular velocity sensor 250R and the effect of centrifugal force r on angular velocity sensor 250Y is sin φ: cos φ. That is, multiplying the output of angular velocity sensor 250Y by sin φ/cos φ can provide the angular velocity regarding the dynamic tilt that is erroneously detected by angular velocity sensor 250R.

### [3-3. Step 3 and Step 4]

Erroneous detection amount calculator 320 calculates the amount of erroneous detection of the dynamic tilt. Then, as Step 3, subtractor 330 obtains information on the angular velocity indicating the amount of erroneous detection of the dynamic tilt from erroneous detection amount calculator 320 and obtains information on the angular velocity in the roll direction of digital video camera 100 from angular velocity sensor 250R. Subtractor 330 subtracts the obtained information on the angular velocity indicating the amount of erroneous detection of the dynamic tilt from the obtained information on the angular velocity in the roll direction. Thus, subtractor 330 can provide the information on the angular velocity indicating the dynamic tilt to be corrected.

As Step 4, adder 340 adds the information on the inclination angle calculated in Step 1 to the value obtained by multiplying the information on the dynamic tilt to be corrected, which has been calculated in Step 3, by the period of the vertical synchronizing signal. Thus, the amount of tilt to be corrected is calculated. Adder 340 outputs the information on the calculated tilt to image processor 160.

Based on the information on the calculated tilt, image processor 160 adjusts the clipping position of the image generated by CMOS image sensor 140. Thus, digital video camera 100 can correct the tilt more precisely.

### [4. Effect]

As described above, digital video camera 100 of this exemplary embodiment includes the following elements: CMOS image sensor 140; angular velocity sensor 250R; angular velocity sensor 250Y; acceleration sensor 260; and controller 180. CMOS image sensor 140 images the light condensed by optical system 110 and generates image data. Angular velocity sensor 250R detects a first angular velocity, i.e. an angular velocity around a first axis, which is substantially parallel to the optical axis of optical system 110. Angular velocity sensor 250Y detects a second angular velocity, i.e. an angular velocity around a second axis, which is substantially perpendicular to a horizontal plane when the digital video camera is placed on the horizontal plane. Acceleration sensor 260 detects an angle of rotation around a third axis, which is substantially perpendicular to the plane formed by the first axis and the second axis. Controller 180 processes information about the first angular velocity, based on the information about the second angular velocity and the information about the angle.

With this configuration, digital video camera 100 can more precisely detect a tilt in the direction of rotation around the axis substantially parallel to the optical axis.

Digital video camera 100 of this exemplary embodiment further includes image processor 160. Based on the information about the first angular velocity after the processing performed by controller 180, image processor 160 corrects the whole or part of the effect, which is exerted on the image data generated by CMOS image sensor 140, of the rotation around the first axis.

With this configuration, digital video camera 100 of this exemplary embodiment can correct the tilt more precisely.

### Other Exemplary Embodiments

The description of the first exemplary embodiment has been presented as an example of the technique disclosed in the present application. However, the technique of the present disclosure is not limited to the above. The technique of the present disclosure is applicable to other exemplary embodiments subjected to modifications, replacements, additions, omissions, or the like as needed. Further, respective elements described in the first exemplary embodiment may be combined so as to provide other exemplary embodiments.

Hereinafter, other exemplary embodiments are described.

In the first exemplary embodiment, digital video camera 100 corrects a tilt by adjusting the clipping position of the image taken by CMOS image sensor 140. However, the present disclosure is not limited to this configuration necessarily. For instance, CMOS image sensor 140 may be rotated based on a detected tilt.

In the first exemplary embodiment, the technique of the present disclosure is used in digital video camera 100. However, the present disclosure is not limited to this configuration necessarily. The present disclosure can be used in a lens-replaceable digital camera, for example.

In the first exemplary embodiment, digital video camera 100 precisely corrects a tilt in the roll direction, based on the information on an angular velocity in the yaw direction, the information on an angular velocity in the roll direction, and the information on a tilt angle. However, the present disclosure is not limited to this configuration necessarily. For instance, a tilt in the pitch direction may be corrected precisely or a tilt in the yaw direction may be corrected precisely.

The exemplary embodiments have been described as examples of the technique of the present disclosure. For this purpose, the accompanying drawings and detailed description are provided.

Therefore, elements shown in the accompanying drawings and the detailed description may include not only essential elements that need to be used for solving the problem, but also non-essential elements that do not have to be used for solving the problem and are only used for showing the examples of the above technique. For this reason, these non-essential elements should not be instantly construed as essential elements simply because these elements are shown in the accompanying drawings and the detailed description.

Further, the above exemplary embodiments are intended to give examples of the technique of the present disclosure, and thus can be subjected to various modifications, replacements, additions, omissions, or the like within the scope of the claims or within the equivalent scope.

What is claimed is:

1. An imaging apparatus comprising:
an imaging part for imaging light condensed by an optical system and for generating image data;
a first sensor for detecting a first angular velocity that is an angular velocity around a first axis substantially parallel to an optical axis of the optical system;
a second sensor for detecting a second angular velocity that is an angular velocity around a second axis substantially perpendicular to a horizontal plane when the apparatus is placed on the horizontal plane;
a third sensor for detecting an angle of rotation around a third axis substantially perpendicular to a plane formed by the first axis and the second axis; and
a processor for processing information about the first angular velocity, based on information about the second angular velocity and information about the angle.

2. The imaging apparatus of claim 1, further comprising a correction part for correcting, based on the information about the first angular velocity after the processing performed by the processor, whole or part of an effect of rotation around the first axis, the effect being exerted on the image data generated by the imaging part.

3. A detecting apparatus comprising:
a first sensor for detecting a first angular velocity that is an angular velocity around a first axis substantially parallel to an optical axis of an optical system;
a second sensor for detecting a second angular velocity that is an angular velocity around a second axis substantially perpendicular to a horizontal plane when the apparatus is placed on the horizontal plane;
a third sensor for detecting an angle of rotation around a third axis substantially perpendicular to a plane formed by the first axis and the second axis; and
a processor for processing information about the first angular velocity, based on information about the second angular velocity and information about the angle.
